(19) United States
(12) Patent Application Publication
(10) Pub. No.: US 2011/0071685 A1
(43) Pub. Date: Mar. 24, 2011

(54) CREATION AND USE OF SOFTWARE DEFINED BUILDING OBJECTS IN BUILDING MANAGEMENT SYSTEMS AND APPLICATIONS

(75) Inventors: Timothy D. Huneycutt, Perry, OK (US); Gheorge L. Vacariuc, Arnold, MO (US)

(73) Assignee: Johnson Controls Technology Company

(21) Appl. No.: 12/887,390

(22) Filed: Sep. 21, 2010

Related U.S. Application Data
(63) Continuation-in-part of application No. 12/874,961, filed on Sep. 2, 2010.
(60) Provisional application No. 61/277,223, filed on Sep. 22, 2009.
(60) Provisional application No. 61/239,738, filed on Sep. 3, 2009.

(51) Int. Cl. G05B 15/00

(52) U.S. Cl. 700/275

(57) ABSTRACT

A computing system for providing a software defined building object to applications of a building management system is shown and described. The computing system includes an interface configured to receive building management system inputs from the building management system. The computing system further includes a memory device. The computing system further includes a processing circuit configured to define a software defined building object and to relate building management system inputs received at the interface to the software defined building object. The processing circuit is configured to store the software defined building object in the memory device and to expose the software defined building object to at least one service accessible by the applications of the building management system.

### CROSS-REFERENCE TO RELATED APPLICATIONS

This is a continuation-in-part of application Ser. No. 12/874,961, filed Sep. 2, 2010, incorporated by reference in its entirety, which claims the benefit of U.S. Provisional Application No. 61/239,738, filed Sep. 3, 2009, which is incorporated by reference in its entirety. The present application also claims the benefit of U.S. Provisional Application No. 61/277,223, filed Sep. 22, 2009, the entirety of which is hereby incorporated by reference.

### BACKGROUND

The present invention relates generally to the field of building management systems.

A building management system (BMS) is, in general, a system of devices configured to control, monitor, and manage equipment in or around a building or building area. A BMS can include a heating, ventilation, and air conditioning (HVAC) system, a security system, a lighting system, a fire alerting system, an elevator system, a water management system, a food storage system, a telephone system, another system that is capable of managing building functions or devices, or any combination thereof. BMS devices may be installed in any environment (e.g., an indoor area or an outdoor area) and the environment may include any number of buildings, spaces, zones, rooms, or areas. A BMS may include METASYS building controllers or other devices sold by Johnson Controls, Inc., as well as building devices and components from other sources.

A BMS may include one or more computer systems (e.g., servers, BMS controllers, etc.) that serve as enterprise level controllers, application or data servers, head nodes, master controllers, or field controllers for the BMS. Such computer systems may communicate with multiple downstream building systems or subsystems (e.g., an HVAC system, a security system, etc.) according to like or disparate protocols (e.g., LON, BACnet, etc.). The computer systems may also provide one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with the BMS, its subsystems, and devices.

### SUMMARY

One embodiment of the present invention relates to a method for providing a software defined building object to applications of a building management system. The method includes creating a software defined building object in a memory device, mapping a group of building devices or inputs of the building management system to the software defined building object, and exposing the software defined building object to at least one service accessible by applications associated with the building management system.

Another embodiment of the present invention relates to a computing system for providing a software defined building object to applications of a building management system. The computing system includes an interface configured to receive building management system inputs from the building management system. The computing system further includes a memory device. The computing system further includes a processing circuit configured to define a software defined building object and to relate building management system inputs received at the interface to the software defined building object. The processing circuit is configured to store the software defined building object in the memory device and to expose the software defined building object to at least one service accessible by the applications of the building management system.

Yet another embodiment of the present invention relates to computer-readable media with computer-executable instructions embodied thereon that when executed by a computing system perform a method for providing a software defined building object to applications of a building management system. The media includes instructions for creating a software defined building object, instructions for mapping a group of building devices or inputs of the building management system to the software defined building object, and instructions for exposing the software defined building object to at least one service accessible by applications associated with the building management system. The media may include instructions for creating and associating a different software defined building object with each of a plurality of physical building spaces. The media may further include instructions for providing each software defined building object with at least one method for affecting the energy use associated with the physical building space.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1A is a perspective view of a building including a BMS, according to an exemplary embodiment;

FIG. 1B is a block diagram of the BMS of the building of FIG. 1A, according to an exemplary embodiment;

FIG. 1C is a block diagram of a computer system of the BMS of the building shown in FIG. 1A, according to an exemplary embodiment;

FIGS. 2A-C are exemplary graphical user interfaces for allowing developers to view software defined building objects; and

FIGS. 2D-E are exemplary graphical user interfaces for allowing developers to view or interact with software defined building objects.

### DETAILED DESCRIPTION

Before turning to the figures, which illustrate the exemplary embodiments in detail, it should be understood that the disclosure is not limited to the details or methodology set forth in the description or illustrated in the figures. It should also be understood that the terminology is for the purpose of description only and should not be regarded as limiting.

Embodiments of the present disclosure include a computer system for a BMS that has been configured to help make differences in building subsystems transparent at the human-machine interface, application, or client interface level. The computing system is configured to provide access to different building devices and building subsystems using common or unified building objects (e.g., software objects stored in memory) to provide the transparency. In an exemplary embodiment, a software defined building object (e.g., “virtual building object”, “virtual device”) groups multiple properties from disparate building systems and devices into a single software object that is stored in memory and provided by a computer system for interaction with other systems or applications (e.g., front-end applications, control applications, remote applications, client applications, local processes, etc.). Multiple software defined building objects may be described as forming an abstraction layer of a BMS software framework or architecture. Benefits such as allowing developers to write applications that will work regardless of a particular building subsystem makeup (e.g., particular naming conventions, particular protocols, etc.) may be provided by such software defined building objects.

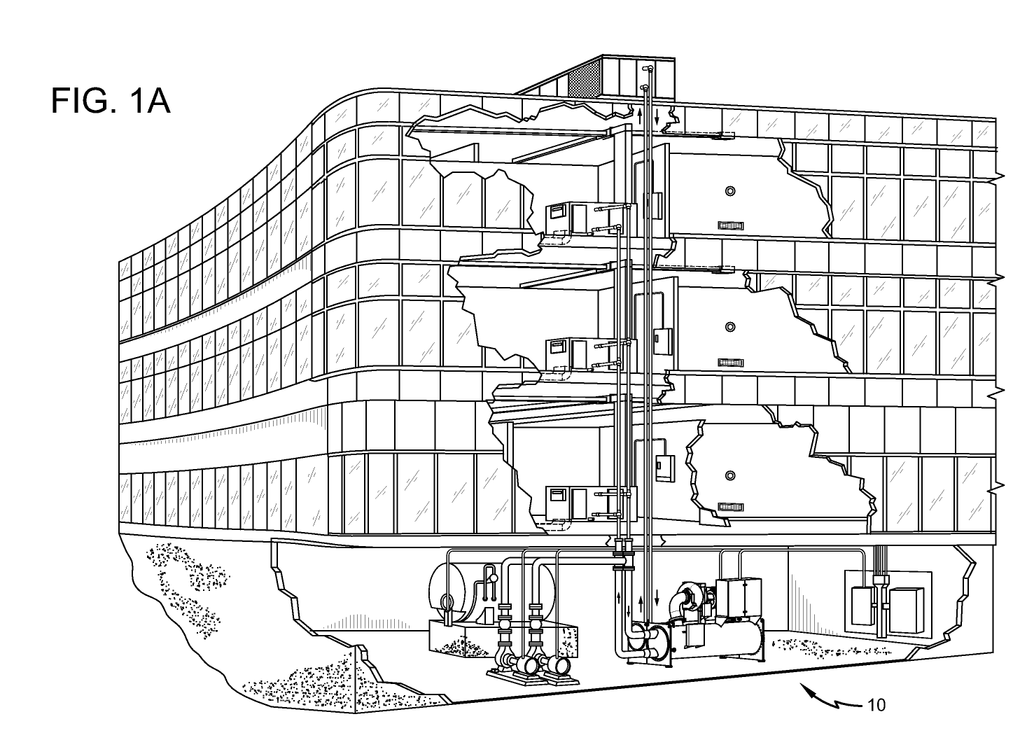

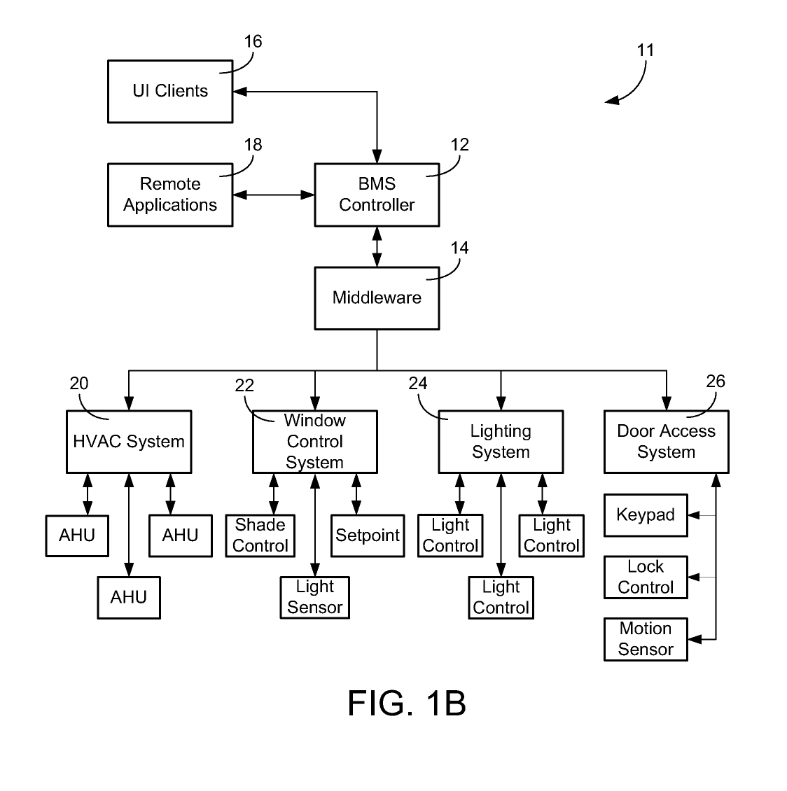

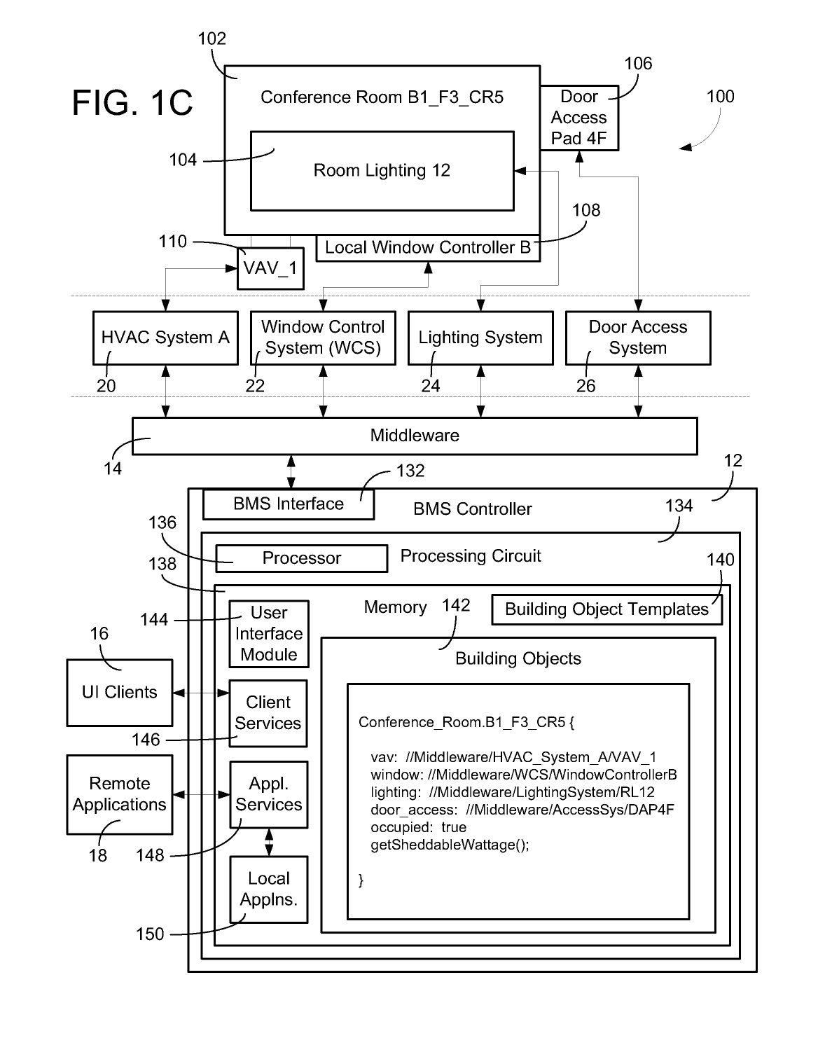

Referring now to FIG. 1A, a perspective view of a building 10 is shown, according to an exemplary embodiment. A BMS serves building 10. The BMS for building 10 may include any number or type of devices that serve the building. For example, each floor may include one or more security devices, video surveillance cameras, fire detectors, smoke detectors, lighting systems, HVAC systems, or other building systems or devices. In modern BMSs, BMS devices can exist on different networks within the building (e.g., one or more wireless networks, one or more wired networks, etc.) and yet serve the same building space or control loop. For example, devices may be connected to different communications networks or field controllers even if the devices serve the same area or equipment.

Referring now to FIG. 1B, a block diagram of an exemplary BMS 11 for building 10 of FIG. 1A is shown. BMS 11 is shown to include a plurality of BMS subsystems 20-26. Each BMS subsystem 20-26 is connected to a plurality of BMS devices and makes data points for varying connected devices available to upstream BMS controller 12.

As illustrated in FIG. 1B, a BMS subsystem including HVAC system 20 is connected to multiple AHUs. HVAC system 20 may receive data from the AHUs (e.g., a temperature setpoint, a damper position, temperature sensor readings) from the AHUs. HVAC system 20 may then provide such BMS inputs up to middleware 14 and BMS controller 12. Similarly, other BMS subsystems may receive inputs from other building objects and provide the BMS inputs to middle 14 and BMS controller 12. For example, a window control system 22 may receive shade control information from one or more shade controls, window control system 22 may receive ambient light level information from one or more light sensors, or window control system 22 may receive other BMS inputs (e.g., sensor information, setpoint information, current state information, etc.) from downstream devices such as shade controls. Lighting system 24 may receive lighting related information from a plurality of downstream light controls. Door access system 26 may receive lock control, motion, state, or other door related information from a plurality of downstream door controls.

BMS subsystems 20-26 are shown as connected to BMS controller 12 via middleware 14 and are configured to provide BMS controller 12 with BMS inputs from the various BMS subsystems 20-26 and their varying downstream devices.

BMS controller 12 is configured to make differences in building subsystems transparent at the human-machine interface or client interface level (e.g., for connected or hosted user interface (UI) clients 16, remote applications 18, etc.). BMS controller 12 is configured to describe or model different building devices and building subsystems using common or unified building objects (e.g., software objects stored in memory) to provide the transparency. Benefits such as allowing developers to write applications that will work regardless of the building subsystem makeup may be provided by such software building objects. For example, BMS controller 12 may group inputs from the various subsystems 20-26 to create a building object “Conference_Room.B1_F3_CR5” including inputs from various systems controlling the environment in the room.

An exemplary software defined building object might be an object such as:

```
Conference_Room.B1_F3_CR5 {
    vav: //Middleware/HVAC_System_A/VAV_1;
    window: //Middleware/WCS/WindowControllerB;
    lighting: //Middleware/LightingSystem/RL12;
    door_access: //Middleware/AccessSys/DAP4F;
    occupied: true;
    getSheddableWattage( );
}
```

The software defined building object's name is “Conference_Room.B1_F3_CR5” which may conform to a naming convention indicating that it is a conference room in a particular location in the building. The building object “Conference_Room.B1_F3_CR5” has several values or attributes: vav, window, lighting, door_access, occupied, and getSheddableWattage that are mapped to the particular BMS resources of “HVAC_System_A/VAV_1,” “WCS/WindowControllerB,” “LightingSystem/RL12,” and “AccessSys/DAP4F,” respectively. The mapping provides a description for BMS or computing resources (e.g., back end software applications, client applications, BMS control routines, etc.) so that the BMS or other computing resources can identify, access, display, change or otherwise interact with the software defined building object in a meaningful way (e.g., in a way that allows changes to be made to the mapped devices). A software defined building object may be mapped to BMS inputs manually. For example, the mapping may be completed by a user with a graphical user interface tool that requires a user to either type in or “drag and drop” BMS inputs to an object. Software defined building objects may also or alternatively be mapped to BMS inputs by computerized systems configured to provide varying degrees of mapping automation. For example, patent application Ser. No. 12/874,961, filed Sep. 2, 2010 and incorporated herein by reference in its entirety, describes systems and methods for mapping BMS inputs to software defined building objects.

As an example of how a building object may be used by the system, all room building objects serving a room may have the same attributes as “Conference_Room.B1_F3_CR5” listed above. Once each of the rooms in building 10 are mapped to a software defined “room” building object, the rooms may be treated the same way in code existing in BMS controller 12, remote applications 18, or UI clients 16. Accordingly, an engineer writing software code for UI clients 16, remote applications 18 or BMS controller 12 can know that each room will have attributes listed above (e.g., VAV, window, lighting, door access, occupied, getSheddableWattage( )). Therefore, for example, rather than having to know an address for a particular variable air volume controller in a particular HVAC system, a given room's VAV controller may be available at the room's vav attribute.

Referring now to the block diagram of FIG. 1C, software defined building object 142 named “Conference_Room.B1_F3_CR5” is illustrated as existing within memory 138 of a BMS controller 12 associated with a BMS. Software defined building object 142 represents a physical building space (i.e., a conference room named “B1_F3_CR5”).

As is illustrated in FIG. 1C, many different building devices connected to many different BMS subsystems affect conference room “B1_F3_CR5.” For example, conference room 102 illustrated at the top of FIG. 1C includes or is otherwise affected by a variable air volume box 110 named “VAV_1,” a local window controller 108 (e.g., a blind controller) named “Local Window Controller B,” a group of lights 104 named “Room Lighting 12,” and a door access pad 106 named “Door access pad 4F.” Each of these building devices may include local control circuitry configured to provide signals to their supervisory controllers or more generally to the BMS subsystem to which they belong. For example, VAV_1 110 may include circuitry that affects an actuator in response to control signals received from a field controller that is a part of HVAC system 20, Local Window Controller B 108 may include circuitry that affects windows or blinds in response to control signals received from a field controller that is part of window control system (WCS) 22, “Room Lighting 12” 104 may include circuitry that affects the lighting in response to control signals received from a field controller that is part of lighting system 24, and “Door Access Pad 4F” 106 may include circuitry that affects door access (e.g., locking or unlocking the door) in response to control signals received from a field controller that is part of door access system 26. In conventional buildings, the subsystems are typically managed separately, particularly if they are from different manufacturers or communicate according to different protocols. Further, conventional control software in such buildings is typically custom written to account for the particular differences in subsystems, protocols, and the like. A software defined building object of the present disclosure is intended to group otherwise ungrouped or unassociated devices so that the group may be addressed or handled by applications together and in a consistent manner. For example, a conference room building object may be created in memory for each conference room in the building. Further, each conference room building object may include the same attribute, property, and/or method names as those shown in FIG. 1C. For example, each conference room may include a variable air volume box attribute, a window attribute, a lighting attribute, and a door access device attribute. Such an architecture and collection of building objects is intended to allow developers to create common code for use in buildings regardless of the type, protocol, or configuration of the underlying BMS subsystems. For example, a single application may be developed to restrict ventilation to conference rooms when the conference rooms are not in use (e.g., when the occupied attribute is equal to “true”). Assuming proper middleware and communications systems, the setup or the installation of an application for a different BMS need not include a re-write of the application code. Instead, for example, conference room building objects need only be created and variable air volume units mapped to the conference room building objects.

Referring still to FIG. 1C, BMS controller 12 is shown to include a BMS interface 132 in communication with middleware 14 of the BMS. Middleware 14 is generally a set of services that allow interoperable communication to, from, or between disparate BMS subsystems 20-26 of the BMS (e.g., HVAC systems from different manufacturers, HVAC systems that communicate according to different protocols, security/fire systems, IT resources, door access systems, etc.). Middleware 14 may be, for example, an EnNet server sold by Johnson Controls, Inc. While middleware 14 is shown as separate from BMS controller 12, in various exemplary embodiments middleware 14 and computer system 12 are integrated. For example, middleware 14 may be a part of BMS controller 12.

BMS interface 132 (e.g., a communications interface) can be or include wired or wireless interfaces (e.g., jacks, antennas, transmitters, receivers, transceivers, wire terminals, etc.) for conducting data communications with another system or network. For example, BMS interface 132 can include an Ethernet card and port for sending and receiving data via an Ethernet-based communications network. In another example, BMS interface 132 includes a WiFi transceiver for communicating via a wireless communications network. BMS interface 132 may be configured to communicate via local area networks or wide area networks (e.g., the Internet, a building WAN, etc.). BMS interface 132 is configured to receive building management inputs from middleware 14 or directly from one or more BMS subsystems 20-26. BMS interface 132 can include any number of software buffers, queues, listeners, or other communications-supporting services.

BMS controller 12 is further shown to include a processing circuit 134 including a processor 136 and memory 138. Processor 136 may be a general purpose or specific purpose processor, an application specific integrated circuit (ASIC), one or more field programmable gate arrays (FPGAs), a group of processing components, or other suitable processing components. Processor 136 is configured to execute computer code or instructions stored in memory 138 or received from other computer readable media (e.g., CDROM, network storage, a remote server, etc.). According to an exemplary embodiment, memory 138 is communicably connected to processor 136 via electronics circuitry. Memory 138 (e.g., memory unit, memory device, storage device, etc.) is one or more devices for storing data and/or computer code for completing and/or facilitating the various processes described in the present disclosure. Memory 138 may be RAM, hard drive storage, temporary storage, non-volatile memory, flash memory, optical memory, or any other suitable memory for storing software objects and/or computer instructions. Memory 138 may include database components, object code components, script components, or any other type of information structure for supporting the various activities and information structures described in the present disclosure. Memory 138 includes computer code for executing (e.g., by processor 136) one or more processes described herein. When processor 136 executes instructions stored in memory 138 for completing the various activities described herein, processor 136 generally configures BMS controller 12 and more particularly processing circuit 134 to complete such activities.

Memory 138 is shown to include client services 146 configured to allow interaction between internal or external clients or applications and BMS controller 12. Client services 146, for example, may include web services or application programming interfaces available for communication by UI clients 16 and remote applications 18 (e.g., an energy monitoring application, an application allowing a user to monitor the performance of the BMS, an automated fault detection and diagnostics system, etc.).

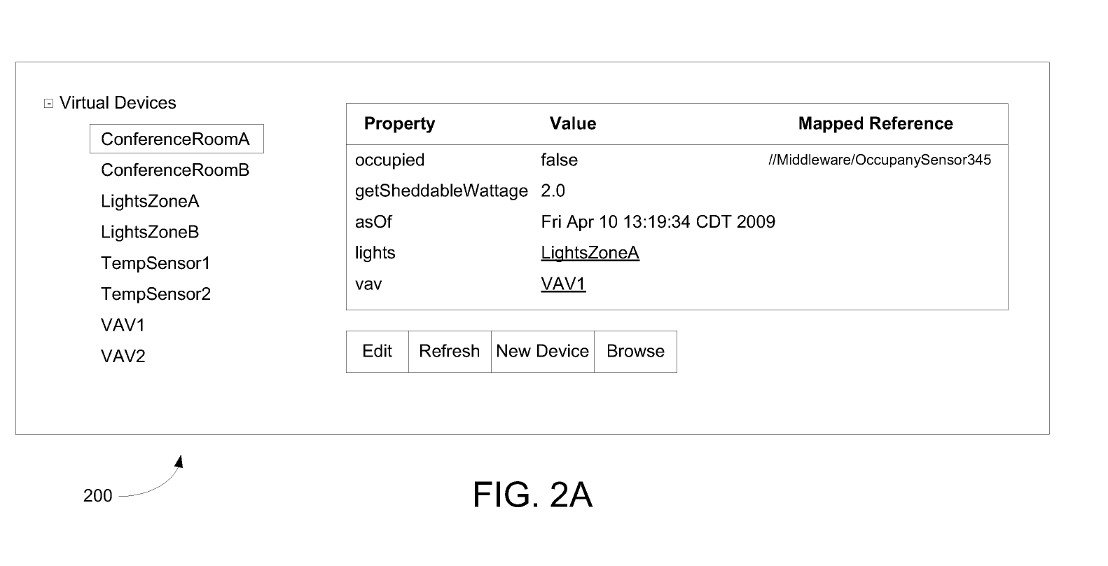

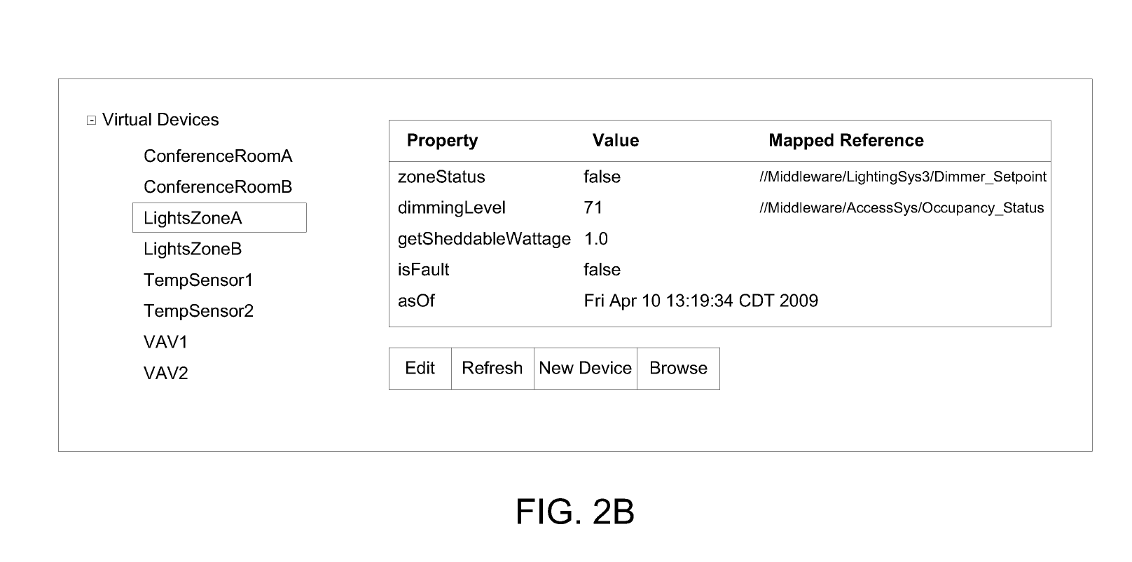

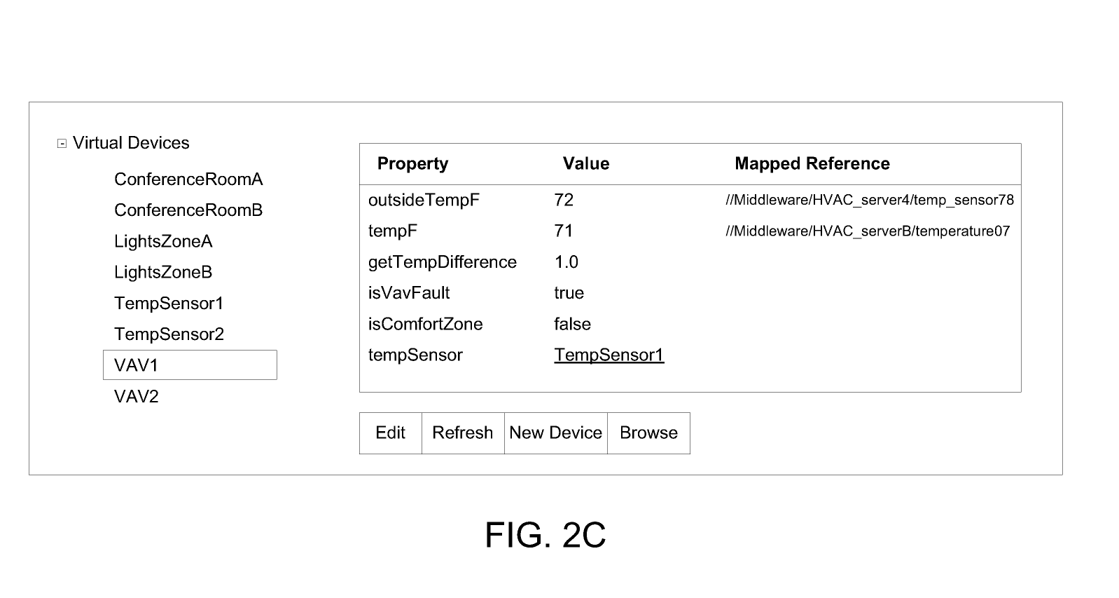

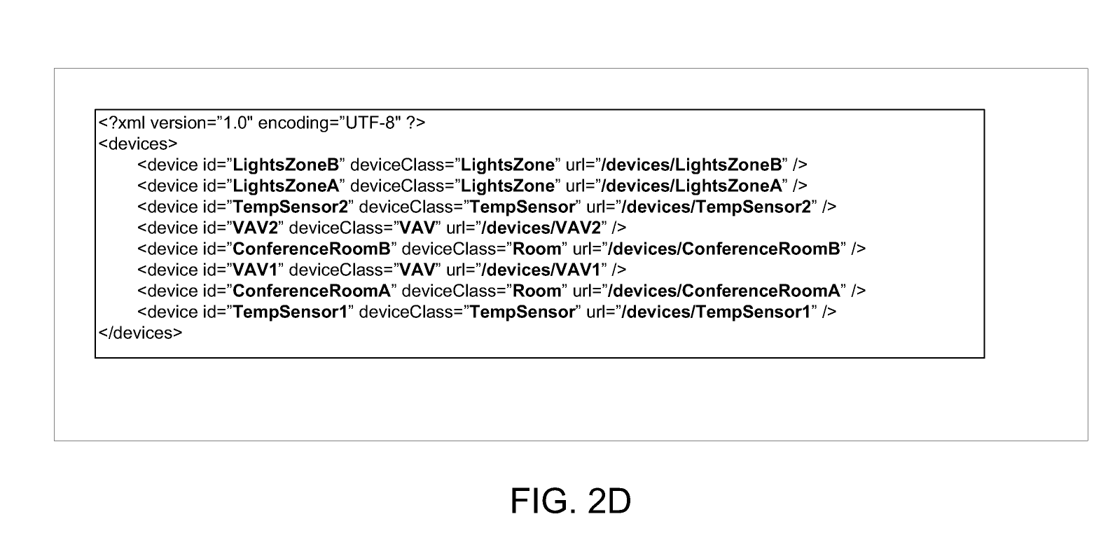

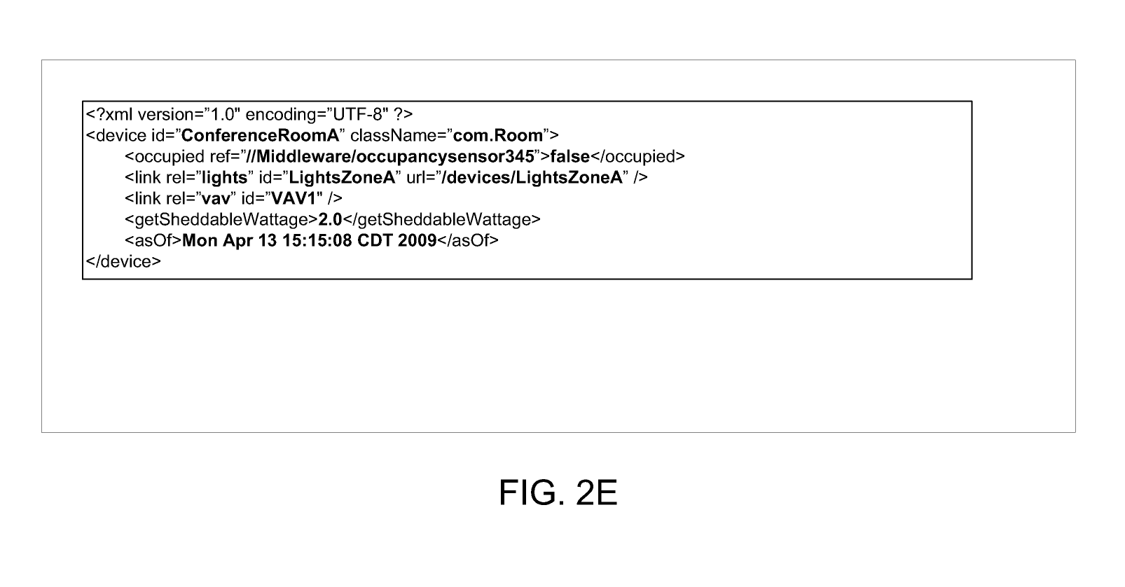

Memory 138 further includes user interface module 144. User interface module 144 is configured to generate one or more user interfaces for receiving input from a user. User interface module 144 may be configured to provide, for example, a graphical user interface, a voice driven interface, a text-based interface, or another interface for receiving user input regarding the mapping of BMS inputs to building objects. In an exemplary embodiment, user interface module 144 is an HTML-based application configured to be served by, for example, client services 146 or another web server of BMS controller 12 or another device. User interface module 144 may be configured to prompt a user (e.g., visually, graphically, audibly, etc.) for input regarding building objects. In an exemplary embodiment, user interface module 144 prompts the user to create (or otherwise provides a user interface for creating) a template building object. User interface module 144 may also prompt the user to map BMS inputs to the template building object. User interface module 144 may receive and handle the user inputs to initiate the storage of received input mappings. User interface module 144 may further be configured to generate and serve graphical user interfaces having information displays of building objects. The graphical user interfaces provided by the user interface module may be, for example, similar to the GUIs shown in FIGS. 2A-2E and may be intended to provide a developer with a development tool for writing BMS applications.

Creation of Software Defined Building Objects

The creation of a software defined building object may include three steps:

1. defining a building object template;

2. creating an instance of a building object based on the template; and

3. mapping or binding building object properties or attributes to particular BMS devices or inputs.

As an example of the first step, a conference room template or class may be created (e.g., by a developer, by a rapid application development module, etc.) such as the following:

```
public class Conference_Room extends Device {
    def vav
    def window
    def lighting
    def door_access
    def occupied
    def getSheddableWattage( ) { ... }
}
```

In some embodiments, the building object template or class may be a Groovy/Java class configured to inherit a series of benefits such as the ability to extend existing devices.

An instance of the class may be created and named (for example “B1_F3_CR5”). The names can be descriptive, based on an automated routine configured to find building objects, manually applied, or otherwise.

The mapping or binding process maps disparate BMS devices or inputs to the instance of the building object.

Once the building objects are created and BMS devices or inputs are mapped to the building objects, software defined building objects may be used by applications (local, remote, client, etc.) with any suitable programming language or syntax (e.g., Groovy). As an example of interaction with the software defined building object used in previous examples, the following exemplary piece of code is configured to load “B1_F3_CR5” as ConfRoom, print the result of the method getSheddableWattage for ConfRoom, and set the window parameter to “50” (which may be sent to WCS 22 or “Local Window Controller B” 108 via BMS interface 132 or middleware 14 shown in FIG. 1C to cause the blinds to be 50 percent open) when the ConfRoom object is saved.

def ConfRoom=factory.load(“Conference_Room.B1_F3_CR5”)

printIn ConfRoom.getSheddableWattage( );

ConfRoom1.window=50

factory.save(ConfRoom)

In an exemplary embodiment, application services 148 of BMS controller 12 shown in FIG. 1C may be or include web services configured to allow remote applications 18 or local applications 150 to access the attributes and methods of the software defined building objects directly or indirectly via a set of internet application programming interfaces. To support such interfaces, each software defined building object may include or be exposed to a to XML( ) method configured to describe the software defined building object using XML.

Referring now to FIG. 2A, a graphical user interface (GUI) 200 called “Virtual Devices Explorer” is shown, according to an exemplary embodiment. GUI 200 is intended to allow developers to view software defined building objects (i.e. “virtual devices”) and their properties. The software defined building objects can also be edited, created, browsed, interacted with, or otherwise manipulated and GUI 200 may be used as a developer's tool. In the example shown in FIG. 2A, ConferenceRoomA is selected and its current properties are shown in GUI 200. For example, ConferenceRoomA has an “occupied” property which is mapped to a particular occupancy sensor (e.g., //Middleware/OccupanySensor345”). In the exemplary embodiment shown, “getSheddableWattage” is a method associated with the ConferenceRoomA building object. When executed, “getSheddableWattage” may output the amount of energy (e.g., expressed in wattage or otherwise) that may be reduced (i.e., “shed”) for the conference room. In an exemplary embodiment, a process running on the computer or another system could be configured to implement a demand/response policy by querying conference rooms for “sheddable” wattage and then reducing energy use (turning off lights, raising cooling setpoints, etc.) in a way that is minimally disruptive to users.

The “getSheddableWattage” method is an example of a service or method that may be associated with a software defined building object. Such a method, as is the case for software defined building object “ConferenceRoomA,” is not inherited from an existing building device (e.g., a VAV controller) and is not associated with any one physical device. Rather, “getSheddableWattage” is a service or method that operates on the “virtual” device of a conference room. According to embodiments of the present disclosure, virtual devices (e.g., representing building spaces rather than devices) are created that include services and methods as well as attributes. The virtual device of the conference room can be interacted with as if it were an actual building device of the BMS. As is true in the conference room example, the virtual devices can be associated with building spaces and group a plurality of physical building devices together that serve the building space. The software defined building objects are exposed to services (e.g., application services 148, client services 146, local applications 150, etc.) and such services may advantageously interact with building spaces via the software defined building objects. Writing code or conducting user-driven control activities relative to building spaces can be more intuitive and easier than writing code or conducting user-driven control activities with addressable device controllers (e.g., a particular VAV controller, etc.).

In some exemplary embodiments, software defined building objects can be nested such that one software defined building object can reference or link to another software defined building object. In GUI 200, for example, the lights and vav attributes of the ConferenceRoomA building object are shown as linked to LightsZoneA and VAV1 which are themselves software-defined building objects. GUI 200 is configured such that clicking on LightsZoneA or VAV1 provides another “device explorer” GUI for those devices (which may be real or other software defined building objects). Accordingly, one software defined building object may be mapped or linked to one or more other software defined building objects and those relationships can be navigated via a GUI such as that shown in FIGS. 2A-C. FIGS. 2B and 2C show the results of clicking on LightsZoneA or VAV1, respectively, from GUI 200 of FIG. 2A.

Application services 148 of BMS controller 12 shown in FIG. 1C can include one or more web services. The web services may be “RESTful web services” or web services configured to manipulate object states (e.g., the states of the software defined software objects) using HTTP methods that affect state, such as POST, GET, PUT or DELETE. The web services may be configured to expose the software defined building objects using XML data that may be parsed by applications (local or remote) or shown to developers or other users such as by the GUI of FIG. 2D. In some exemplary embodiments, application services 148 may include web services for allowing simple HTTP requests to query the system. For example, a web service of BMS controller 12 may be configured to respond to the HTTP request of “http://host-address/devices?class=VAV” with an XML file describing all of the devices in the VAV class. Similarly, a web service of BMS controller 12 may be configured to respond to the HTTP request of “http://host-address/devices/ConferenceRoomA” with an XML file describing “ConferenceRoomA” and its attributes and method results. Such a result is shown, for example, in FIG. 2E.

As shown in FIG. 2E, a GUI or API of BMS controller 12 can be configured to express building object relationships via links using, for example, “<link rel=“lights” id=“LightsZoneA” uri=“/devices/LightsZoneA”/>. The “rel” attribute is intended to represent the name of the relation and the id attribute represents the unique identifier of the building object at the other end of the relation.

Changing the state of a device can be done using POST requests. For example, the following post request may be used to change the “occupied” attribute or state of ConferenceRoomA:

POST /devices/ConferenceRoomA
<?xml version=”1.0” encoding=”UTF-8” ?>
<device id=”ConferenceRoomA” className=”path.devices.Room”>
<occupied>false</occupied>
</device>

In various embodiments, new devices may also be created using an HTTP POST request. For example, a new building object of an air handling unit “AHU1” may be created using the following request:

```
POST /devices
<ahu id=”AHU1” class=”path.devices.AHU”>
    <tempF>[path to particular device and device data point]</tempF>
    <outsideTempF>[path to particular device and device data point]
    </outsideTempF>
</ahu>
```

BMS controller 12 may include a service configured to parse this request and to create an instance of an “AHU” class based on the parsed request.

Processes for Software Defined Building Objects

Processes and services may be developed for software defined building objects of the present disclosure using systems and methods described herein. Particularly, processes and services relating to price or energy reduction of building spaces may be provided. For example, systems, methods, and software defined building objects of the present disclosure may be used to create an executable software process that may be triggered by a pricing message (e.g., real time, near real time, etc.) received from a utility company. The software process is configured to respond to the pricing message by adjusting the setpoints of two variable air volume boxes via software defined building objects for the two VAVs.

The price information message may be of the following format:

```
<priceInfo>
    <price>12</price>
    <goodForPeriod units=”hours”>2</goodForPeriod>
</priceInfo>
```

The price information message could be sent or wrapped via SOAP or sent as XML without SOAP as part of a HTTP POST request. The software process could be implemented as follows:

```
/*** Handles the web service priceUpdate method. **/
def handlePriceUpdate(NodeChild priceInfo, MarkupBuilder xmlResp){
    //get the price and for how long it will be available
    def price = priceInfo.price.toDouble( )
    def goodForPeriod = priceInfo.goodForPeriod.toDouble( )
    //transform to minutes
    if (priceInfo.goodForPeriod.@units == “hours”){
        goodForPeriod *= 60
    }
    //make these adjustments after end of business hours
    def today = new Date( )
    if (today.plus(goodForPeriod).after(endOfBusiness) && price > 11){
        def VAVs = [“ConferenceRoomA.VAV1”,
        “ConfRoomB.VAV2”]
        VAVs.each({
            def vav = factory.load(it)
            if (vav.temp > 74){
                vav.temp −= 2
            }
            factory.save(vav)
        )
    }
}
```

In addition to processes triggered by inbound Web Services requests or information (e.g., the pricing message), similar or different software processes may also be scheduled. Accordingly, instead of receiving a pricing message, the software process above could be triggered every five minutes, request pricing information (request the pricing message from a utility or energy broker) and then apply new setpoints to the VAVs based on the newly updated price. Further, because the software defined building objects of the conference rooms are exposed to the above “handlePriceUpdate” service, the above method is not linked to particular VAV addresses or names.

Fault Detection

Software defined building objects may be used to augment conventional fault detection algorithms. When logical software-defined building objects are exposed to higher level services regardless of underlying protocols, naming conventions or configurations, fault detection services may be developed and distributed independently of any particular HVAC controller, device or protocol. For example, the following code may extend a VAV building object class or template to include an “isDamperFault” method configured to determine if the temperature associated with the VAV is above the setpoint by more than three degrees and whether the damper opening percentage is greater than twenty.

```
public class CustomVAV extends VAV{
    def boolean isDamperFault( ){
        if (temperature - setpoint > 3 && damperOpeningPercent < 20){
            return true
        }else{
            return false
        }
    }
}
```

It should further be noted that building object attributes (e.g., temperature and setpoint) may be mapped to BMS devices or inputs (e.g., sensors, an HVAC controller, etc.) that are not electrically or physically a part of or connected to a physical device (e.g., a physical VAV). For example, the temperature attribute of a software defined VAV device may be mapped to a database point in a BMS, a sensor near the VAV, or otherwise. In other words, a software defined “VAV” may include attributes and methods beyond those of any one VAV controller.

In an exemplary embodiment, BMS controller 12 of FIG. 1C includes an Open Services Gateway initiative (OSGI) service platform intended to provide an execution environment in which computer code modules, modules and services can be installed, updated, and removed during runtime. In other embodiments, other execution environments may be used by BMS controller 12. The execution environment may be configured to advertise and discover module services (e.g., of connected modules) during runtime such that relatively decoupled modules can be used with BMS controller 12.

The embodiments described above may be utilized by software application processes. One example of a process configured to be executed by or used with the architecture described above is a process that exposes a SOAP web service for providing smart grid features. For example, the web service may be configured to accept an electric power demand reduction request from a utility, energy broker, or another source. In response to the demand reduction request the process checks the real-time state of all energy consuming facility systems, the current and near-term occupancy, and use of the facility and the current and forecasted weather conditions in the region of the facility. The process may then be configured to apply an appropriate electrical demand reduction policy to the BMS subsystems, devices, and or processes thereof.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A computing system for providing a software defined building object to applications of a building management system (BMS), comprising:
an interface configured to receive BMS inputs from the BMS;
a memory device; and
a processing circuit configured to define a software defined building object and to relate BMS inputs received at the interface to the software defined building object;
wherein the processing circuit is further configured to store the software defined building object in the memory device and to expose the software defined building object to at least one service accessible by the applications of the BMS.

2. The computing system of claim 1, wherein the processing circuit is configured to relate BMS inputs from different BMS subsystems to the software defined building object.

3. The computing system of claim 2, wherein the software defined building object is configured to represent a physical building space.

4. The computing system of claim 3, wherein the BMS inputs related to the software defined building object are each associated with control of the physical building space.

5. The computing system of claim 4, wherein the at least one service is configured to affect the energy use associated with the physical building space.

6. The computing system of claim 5, wherein the at least one service affects the energy use associated with the physical building space by providing a changed value or a command to a plurality of building devices associated with the physical building space.

7. The computing system of claim 1, wherein the software defined building object includes attributes and services for a plurality of actual building devices.

8. The computing system of claim 7, wherein the plurality of actual devices are physically separate devices.

9. The computing system of claim 7, wherein the plurality of actual devices are logically separate devices.

10. The computing system of claim 7, wherein the plurality of actual devices include at least two building devices coupled to different BMS subsystems and wherein the at least two building devices operate according to different communications protocols.

11. The computing system of claim 1, wherein the software defined building object is not associated with a single building device.

12. A method for providing a software defined building object to applications of a building management system (BMS), comprising:
creating a software defined building object in a memory device;
mapping a group of building devices or inputs of the BMS to the software defined building object; and
exposing the software defined building object to at least one service accessible by applications associated with the BMS.

13. The method of claim 12, wherein the software defined building object is configured to represent a physical building space.

14. The method of claim 13, wherein the group of building devices or inputs mapped to the software defined building object are each related to the physical building space.

15. The method of claim 14, wherein the software defined building object includes an object method configured to allow the applications associated with the BMS to use a single command to affect at least one of the environment of the physical building space and the energy use associated with the physical building space.

16. The method of claim 15, wherein the object method causes a database of historical information to be queried to estimate future energy use associated with the physical building space.

17. The method of claim 12, further comprising:
identifying the group of building devices or inputs of the BMS by analyzing BMS inputs from a plurality of BMS subsystems;
wherein the group of building devices or inputs of the BMS are mapped to the software defined building object as attributes of the software defined building object.

18. The method of claim 12, wherein mapping the group of building devices or inputs of the BMS to the software defined building object comprises:
creating an instance of a building object class; and
assigning attributes of the instantiated building object to paths associated with the group of building devices or inputs of the BMS.

19. The method of claim 18, wherein the at least one service is configured to retrieve the values associated with the building object's attributes and to provide the values to one or more of the applications associated with the BMS upon request.

20. The method of claim 19, wherein the at least one service is further configured to receive requests to change the values associated with the building object's attributes and wherein the at least one service is further configured to cause the building devices or inputs mapped to the attributes to change values or states.
